(19) United States
(12) Patent Application Publication
(10) Pub. No.: US 2025/0026897 A1
(43) Pub. Date: Jan. 23, 2025

(54) HIGH STIFFNESS BIAXIALLY ORIENTED POLYETHYLENE FILMS

(71) Applicant: Dow Global Technologies LLC, Midland, MI (US)

(72) Inventor: Jian Wang, Freeport, TX (US)

(73) Assignee: Dow Global Technologies LLC, Midland, MI (US)

(21) Appl. No.: 18/709,160

(22) PCT Filed: Nov. 9, 2022
(86) PCT No.: PCT/US2022/079549

§ 371 Date: May 10, 2024

Related U.S. Application Data
(60) Provisional application No. 63/278,749, filed on Nov. 12, 2021.

(51) Int. Cl. C08J 5/18

(52) U.S. Cl. CPC C08J 5/18; C08J 2323/04

(57) ABSTRACT

A film having at least one layer, and the layer includes a multimodal high density polyethylene having: a melt index (I₂) that is from 0.8 g/10 min to 5.0 g/10 min; a density that is from 0.950 g/cc to 0.965 g/cc; a polydispersity (Mw/Mn) that is from 10 to 20; and a molecular weight (Mz) that is from 500,000 g/mol to 1,000,000 g/mol. The film is a biaxially oriented polyethylene film.

### CROSS-REFERENCE TO RELATED APPLICATION

This application claims the benefit of and priority to U.S. Application Ser. No. 63/278,749 filed on Nov. 12, 2021, and entitled “HIGH STIFFNESS BIAXIALLY ORIENTED POLYETHYLENE FILMS,” the entire contents of which are incorporated by reference in the present disclosure.

### TECHNICAL FIELD

Embodiments of the present disclosure are generally related to biaxially oriented polyethylene (BOPE) films, and are more particularly related to BOPE films having high stiffness.

### BACKGROUND

There is a desire in the market to use BOPE films in laminated flexible food packaging to facilitate recycling of the packaging. Although some commercially available BOPE films offer excellent optical properties as well as toughness, their lack of stiffness and heat resistance limits the use of such BOPE films to a relatively narrow range of applications. The challenge in increasing stiffness in laminated BOPE flexible packaging is the level of high density polyethylene (HDPE) that can be incorporated into the film structure allowing for overall film density/stiffness while still maintaining a robust processing window.

Accordingly, there remains a need for BOPE multilayer films that are recyclable, have suitable stiffness, and good processability.

### SUMMARY

Embodiments of BOPE films incorporating the HDPE described herein meet these needs by providing BOPE films having an improved stiffness and processability window.

In a first aspect, the present invention relates to a film comprising at least one layer, the at least one layer comprising: a multimodal high density polyethylene comprising: a melt index (I₂) that is from 0.8 g/10 min to 5.0 g/10 min; a density that is from 0.950 g/cc to 0.965 g/cc; a polydispersity (Mw/Mn) that is from 10 to 20; and a molecular weight (Mz) that is from 500,000 g/mol to 1,000,000 g/mol, wherein the film is a biaxially oriented polyethylene film.

In a second aspect, the present invention relates to the film of the first aspect, wherein the multimodal high density polyethylene comprises a melt index (I₂) that is from 1.0 g/10 min to 3.0 g/10 min.

A third aspect includes the film of any one of the first or second aspects, wherein the multimodal high density polyethylene comprises a density that is from 0.955 g/cc to 0.960 g/cc.

A fourth aspect includes a film of any one of the first to third aspects, wherein the multimodal high density polyethylene comprises a polydispersity (Mw/Mn) that is from 10 to 15.

A fifth aspect includes a film of any one of the first to fourth aspects, wherein the multimodal high density polyethylene comprises a molecular weight Mz that is from 550,000 g/mol to 900,000 g/mol.

A sixth aspect includes a film of any one of the first to fifth aspects, wherein the multimodal high density polyethylene comprises a melt index ratio (I₁₀/I₂) that is from 5.0 to 15.0.

A seventh aspect includes a film of any one of the first to sixth aspects, wherein the multimodal high density polyethylene comprises a molecular weight Mw that is from 110,000 g/mol to 135,000 g/mol.

An eighth aspect includes a film of any one of the first to seventh aspects, wherein the multimodal high density polyethylene comprises a molecular weight Mn that is from 9,000 g/mol to 10,000 g/mol.

A ninth aspect includes a multilayer film comprising: a core layer comprising a multimodal high density polyethylene comprising: a melt index (I₂) that is from 0.8 g/10 min to 5.0 g/10 min; a density that is from 0.950 g/cc to 0.965 g/cc; a polydispersity (Mw/Mn) that is from 10 to 20; and a molecular weight (Mz) that is from 500,000 g/mol to 1,000,000 g/mol; a first layer positioned on a first side of the core layer; and a second layer positioned on a second side of the core layer.

A tenth aspect includes the multilayer film of the ninth aspect, wherein at least one of the first layer and the second layer comprises the multimodal high density polyethylene comprising: a melt index (12) that is from 0.8 g/10 min to 5.0 g/10 min; a density that is from 0.950 g/cc to 0.965 g/cc; a polydispersity (Mw/Mn) that is from 10 to 20; and a molecular weight (Mz) that is from 500,000 g/mol to 1,000,000 g/mol.

An eleventh aspect includes the multilayer film of any one of the ninth or tenth aspects, wherein the first layer and the second layer are made from the same material.

A twelfth aspect includes the multilayer film of any one of the ninth to eleventh aspects, wherein a first side of the first layer is positioned on the first side of the core layer and a first side of the second layer is positioned on the second side of the core layer, a third layer is positioned on a second side of the first layer, and a fourth layer is positioned on a second side of the second layer.

A thirteenth aspect includes the multilayer film of any one of the ninth to twelfth aspects, wherein the multilayer film comprises a haze from 2% to 70%.

A fourteenth aspect includes the multilayer film of any one of the ninth to thirteenth aspects, wherein the multilayer film comprises a 1% secant modulus in MD (machine direction) that is from 500 MPa to 2500 MPa.

A fifteenth aspect includes a flexible package, sachet, pouch, or stand-up pouch comprising the film of any one of the first to eighth aspects or the multilayer film of any one of the ninth to fourteenth aspects.

These and other embodiments are described in more detail in the following Detailed Description and the Drawings.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene-based polymer” shall mean polymers comprising greater than 50% by mole of units that have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm.

The term “LLDPE” includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.945 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.945 g/cc up to about 0.980 g/cc, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.909 g/cc, which are generally prepared with Ziegler-Natta catalysts, single-site catalysts including, but not limited to, bis-metallocene catalysts and constrained geometry catalysts, and post-metallocene, molecular catalysts. The term “propylene-based polymer,” as used herein, refers to a polymer that comprises, in polymerized form, refers to polymers comprising greater than 50% by weight of units that have been derived from propylene monomer. This includes propylene homopolymer, random copolymer polypropylene, impact copolymer polypropylene, propylene/α-olefin interpolymer, and propylene/α-olefin copolymer. These polypropylene materials are generally known in the art.

“Multilayer film” means any structure having more than one layer. For example, the multilayer structure may have two, three, four, five or more layers. A multilayer film may be described as having the layers designated with letters. For example, a three layer structure having a core layer B, and two external layers A and C may be designated as A/B/C. Likewise, a structure having two core layers B and C and two external layers A and D would be designated A/B/C/D. Additionally, the skilled person would know that further layers E, F, G, etc. may also be incorporated into this structure.

As used herein, “multimodal” means compositions that can be characterized by having at least two (2) polymer subcomponents with varying densities and weight averaged molecular weights and, optionally, may also have different melt index values. In one embodiment, multimodal may be defined by having at least two distinct peaks in a Gel Permeation Chromatography (GPC) chromatogram showing the molecular weight distribution. In another embodiment, multimodal may be defined by having at least two distinct peaks in a Crystallization Elution Fractionation (CEF) chromatogram showing the short chain branching distribution. Multimodal includes resins having two peaks as well as resins having more than two peaks, such as, for example, three peaks or four peaks.

Reference will now be made in detail to BOPE film embodiments of the present disclosure, wherein the BOPE film comprises a multimodal HDPE as disclosed and described herein. Some embodiments include multilayer films having at least one layer comprising a multimodal HDPE as disclosed and described herein.

The BOPE films disclosed and described herein have at least one layer that comprises a multimodal HDPE having an melt index (I₂) that is from 0.5 g/10 min to 10.0 g/10 min, a density that is from 0.940 g/cc to 0.965 g/cc, a polydispersity (Mw/Mn) that is from 10 to 20, and a molecular weight (Mz) that is from 500,000 g/mol to 1,000,000 g/mol.

### High Density Polyethylene

In embodiments, the multimodal HDPE has a melt index (I₂) from 0.8 g/10 min to 5.0 g/10 min, such as 1.0 g/10 min to 5.0 g/10 min, 1.5 g/10 min to 5.0 g/10 min, 2.0 g/10 min to 5.0 g/10 min, 2.5 g/10 min to 5.0 g/10 min, 3.0 g/10 min to 5.0 g/10 min, 3.5 g/10 min to 5.0 g/10 min, 4.0 g/10 min to 5.0 g/10 min, 4.5 g/10 min to 5.0 g/10 min, 0.8 g/10 min to 4.5 g/10 min, 1.0 g/10 min to 4.5 g/10 min, 1.5 g/10 min to 4.5 g/10 min, 2.0 g/10 min to 4.5 g/10 min, 2.5 g/10 min to 4.5 g/10 min, 3.0 g/10 min to 4.5 g/10 min, 3.5 g/10 min to 4.5 g/10 min, 4.0 g/10 min to 4.5 g/10 min, 0.8 g/10 min to 4.0 g/10 min, 1.0 g/10 min to 4.0 g/10 min, 1.5 g/10 min to 4.0 g/10 min, 2.0 g/10 min to 4.0 g/10 min, 2.5 g/10 min to 4.0 g/10 min, 3.0 g/10 min to 4.0 g/10 min, 3.5 g/10 min to 4.0 g/10 min, 0.8 g/10 min to 3.5 g/10 min, 1.0 g/10 min to 3.5 g/10 min, 1.5 g/10 min to 3.5 g/10 min, 2.0 g/10 min to 3.5 g/10 min, 2.5 g/10 min to 3.5 g/10 min, 3.0 g/10 min to 3.5 g/10 min, 0.8 g/10 min to 3.0 g/10 min, 1.0 g/10 min to 3.0 g/10 min, 1.5 g/10 min to 3.0 g/10 min, 2.0 g/10 min to 3.0 g/10 min, 2.5 g/10 min to 3.0 g/10 min, 0.8 g/10 min to 2.5 g/10 min, 1.0 g/10 min to 2.5 g/10 min, 1.5 g/10 min to 2.5 g/10 min, 2.0 g/10 min to 2.5 g/10 min, 0.8 g/10 min to 2.0 g/10 min, 1.0 g/10 min to 2.0 g/10 min, 1.5 g/10 min to 2.0 g/10 min, 0.8 g/10 min to 1.5 g/10 min, 1.0 g/10 min to 1.5 g/10 min, or 0.8 g/10 min to 1.0 g/10 min.

In one or more embodiments, the multimodal HDPE has a density from 0.950 g/cc to 0.965 g/cc, such as from 0.952 g/cc to 0.965 g/cc, from 0.955 g/cc to 0.965 g/cc, from 0.958 g/cc to 0.965 g/cc, from 0.960 g/cc to 0.965 g/cc, from 0.962 g/cc to 0.965 g/cc, from 0.950 g/cc to 0.962 g/cc, from 0.952 g/cc to 0.962 g/cc, from 0.955 g/cc to 0.962 g/cc, from 0.958 g/cc to 0.962 g/cc, from 0.960 g/cc to 0.962 g/cc, from 0.950 g/cc to 0.960 g/cc, from 0.952 g/cc to 0.960 g/cc, from 0.955 g/cc to 0.960 g/cc, from 0.958 g/cc to 0.960 g/cc, from 0.950 g/cc to 0.958 g/cc, from 0.952 g/cc to 0.958 g/cc, from 0.955 g/cc to 0.958 g/cc, from 0.950 g/cc to 0.955 g/cc, from 0.952 g/cc to 0.955 g/cc, from 0.950 g/cc to 0.952 g/cc.

In embodiments, the multimodal HDPE has a polydispersity (Mw/Mn) from 10 to 20, such as from 11 to 20, from 12 to 20, from 13 to 20, from 14 to 20, from 15 to 20, from 16 to 20, from 17 to 20, from 18 to 20, from 19 to 20, from 10 to 19, from 11 to 19, from 12 to 19, from 13 to 19, from 14 to 19, from 15 to 19, from 16 to 19, from 17 to 19, from 18 to 19, from 10 to 18, from 11 to 18, from 12 to 18, from 13 to 18, from 14 to 18, from 15 to 18, from 16 to 18, from 17 to 18, from 10 to 17, from 11 to 17, from 12 to 17, from 13 to 17, from 14 to 17, from 15 to 17, from 16 to 17, from 10 to 16, from 11 to 16, from 12 to 16, from 13 to 16, from 14 to 16, from 15 to 16, from 10 to 15, from 11 to 15, from 12 to 15, from 13 to 15, from 14 to 15, from 10 to 14, from 11 to 14, from 12 to 14, from 13 to 14, from 10 to 13, from 11 to 13, from 12 to 13, from 10 to 12, from 11 to 12, or from 10 to 11.

In embodiments, the multimodal HDPE has a melt index ratio (I₁₀/I₂) that is from 5.0 to 15.0, such as from 6.0 to 15.0, from 7.0 to 15.0, from 8.0 to 15.0, from 9.0 to 15.0, from 10.0 to 15.0, from 11.0 to 15.0, from 12.0 to 15.0, from 13.0 to 15.0, from 14.0 to 15.0, from 5.0 to 14.0, from 6.0 to 14.0, from 7.0 to 14.0, from 8.0 to 14.0, from 9.0 to 14.0, from 10.0 to 14.0, from 11.0 to 14.0, from 12.0 to 14.0, from 13.0 to 14.0, from 5.0 to 13.0, from 6.0 to 13.0, from 7.0 to 13.0, from 8.0 to 13.0, from 9.0 to 13.0, from 10.0 to 13.0, from 11.0 to 13.0, from 12.0 to 13.0, from 5.0 to 12.0, from 6.0 to 12.0, from 7.0 to 12.0, from 8.0 to 12.0, from 9.0 to 12.0, from 10.0 to 12.0, from 11.0 to 12.0, from 5.0 to 11.0, from 6.0 to 11.0, from 7.0 to 11.0, from 8.0 to 11.0, from 9.0 to 11.0, from 10.0 to 11.0, from 5.0 to 10.0, from 6.0 to 10.0, from 7.0 to 10.0, from 8.0 to 10.0, from 9.0 to 10.0, from 5.0 to 9.0, from 6.0 to 9.0, from 7.0 to 9.0, from 8.0 to 9.0, from 5.0 to 8.0, from 6.0 to 8.0, from 7.0 to 8.0, from 5.0 to 7.0, from 6.0 to 7.0, or from 5.0 to 6.0.

In one or more embodiments, the multimodal HDPE has a melt index ratio (I₂₁/I₂) that is from 60 to 80, such as from 62 to 80, 65 to 80, 68 to 80, 70 to 80, 72 to 80, 75 to 80 78 to 80, from 60 to 78, from 62 to 78, 65 to 78, 68 to 78, 70 to 78, 72 to 78, 75 to 78, from 60 to 75, from 62 to 75, 65 to 75, 68 to 75, 70 to 75, 72 to 75, from 60 to 72, from 62 to 72, 65 to 72, 68 to 72, 70 to 72, from 60 to 70, from 62 to 70, 65 to 70, 68 to 70, from 60 to 68, from 62 to 68, 65 to 68, from 60 to 65, from 62 to 65, or from 60 to 62.

In embodiments, the multimodal HDPE has a molecular weight (Mn) measured by GPC that is from 9,000 g/mol to 10,000 g/mol, such as from 9,100 g/mol to 10,000 g/mol, from 9,200 g/mol to 10,000 g/mol, from 9,300 g/mol to 10,000 g/mol, from 9,400 g/mol to 10,000 g/mol, from 9,500 g/mol to 10,000 g/mol, from 9,600 g/mol to 10,000 g/mol, from 9,700 g/mol to 10,000 g/mol, from 9,800 g/mol to 10,000 g/mol, from 9,900 g/mol to 10,000 g/mol, from 9,000 g/mol to 9,900 g/mol, from 9,100 g/mol to 9,900 g/mol, from 9,200 g/mol to 9,900 g/mol, from 9,300 g/mol to 9,900 g/mol, from 9,400 g/mol to 9,900 g/mol, from 9,500 g/mol to 9,900 g/mol, from 9,600 g/mol to 9,900 g/mol, from 9,700 g/mol to 9,900 g/mol, from 9,800 g/mol to 9,900 g/mol, from 9,000 g/mol to 9,800 g/mol, from 9,100 g/mol to 9,800 g/mol, from 9,200 g/mol to 9,800 g/mol, from 9,300 g/mol to 9,800 g/mol, from 9,400 g/mol to 9,800 g/mol, from 9,500 g/mol to 9,800 g/mol, from 9,600 g/mol to 9,800 g/mol, from 9,700 g/mol to 9,800 g/mol, from 9,000 g/mol to 9,700 g/mol, from 9,100 g/mol to 9,700 g/mol, from 9,200 g/mol to 9,700 g/mol, from 9,300 g/mol to 9,700 g/mol, from 9,400 g/mol to 9,700 g/mol, from 9,500 g/mol to 9,700 g/mol, from 9,600 g/mol to 9,700 g/mol, from 9,000 g/mol to 9,600 g/mol, from 9,100 g/mol to 9,600 g/mol, from 9,200 g/mol to 9,600 g/mol, from 9,300 g/mol to 9,600 g/mol, from 9,400 g/mol to 9,600 g/mol, from 9,500 g/mol to 9,600 g/mol, from 9,000 g/mol to 9,500 g/mol, from 9,100 g/mol to 9,500 g/mol, from 9,200 g/mol to 9,500 g/mol, from 9,300 g/mol to 9,500 g/mol, from 9,400 g/mol to 9,500 g/mol, from 9,000 g/mol to 9,400 g/mol, from 9,100 g/mol to 9,400 g/mol, from 9,200 g/mol to 9,400 g/mol, from 9,300 g/mol to 9,400 g/mol, from 9,000 g/mol to 9,300 g/mol, from 9,100 g/mol to 9,300 g/mol, from 9,200 g/mol to 9,300 g/mol, from 9,000 g/mol to 9,200 g/mol, from 9,100 g/mol to 9,200 g/mol, or from 9,000 g/mol to 9,100 g/mol.

In one or more embodiments, the multimodal HDPE has a molecular weight (Mw) measured by GPC that is from 110,000 g/mol to 135,000 g/mol, such as from 112,000 g/mol to 135,000 g/mol, from 115,000 g/mol to 135,000 g/mol, from 118,000 g/mol to 135,000 g/mol, from 120,000 g/mol to 135,000 g/mol, from 122,000 g/mol to 135,000 g/mol, from 125,000 g/mol to 135,000 g/mol, from 128,000 g/mol to 135,000 g/mol, from 130,000 g/mol to 135,000 g/mol, from 132,000 g/mol to 135,000 g/mol, from 110,000 g/mol to 132,000 g/mol, from 112,000 g/mol to 132,000 g/mol, from 115,000 g/mol to 132,000 g/mol, from 118,000 g/mol to 132,000 g/mol, from 120,000 g/mol to 132,000 g/mol, from 122,000 g/mol to 132,000 g/mol, from 125,000 g/mol to 132,000 g/mol, from 128,000 g/mol to 132,000 g/mol, from 130,000 g/mol to 132,000 g/mol, from 110,000 g/mol to 130,000 g/mol, from 112,000 g/mol to 130,000 g/mol, from 115,000 g/mol to 130,000 g/mol, from 118,000 g/mol to 130,000 g/mol, from 120,000 g/mol to 130,000 g/mol, from 122,000 g/mol to 130,000 g/mol, from 125,000 g/mol to 130,000 g/mol, from 128,000 g/mol to 130,000 g/mol, from 110,000 g/mol to 128,000 g/mol, from 112,000 g/mol to 128,000 g/mol, from 115,000 g/mol to 128,000 g/mol, from 118,000 g/mol to 128,000 g/mol, from 120,000 g/mol to 128,000 g/mol, from 122,000 g/mol to 128,000 g/mol, from 125,000 g/mol to 128,000 g/mol, from 110,000 g/mol to 125,000 g/mol, from 112,000 g/mol to 125,000 g/mol, from 115,000 g/mol to 125,000 g/mol, from 118,000 g/mol to 125,000 g/mol, from 120,000 g/mol to 125,000 g/mol, from 122,000 g/mol to 125,000 g/mol, from 110,000 g/mol to 122,000 g/mol, from 112,000 g/mol to 122,000 g/mol, from 115,000 g/mol to 122,000 g/mol, from 118,000 g/mol to 122,000 g/mol, from 120,000 g/mol to 122,000 g/mol, from 110,000 g/mol to 120,000 g/mol, from 112,000 g/mol to 120,000 g/mol, from 115,000 g/mol to 120,000 g/mol, from 118,000 g/mol to 120,000 g/mol, from 110,000 g/mol to 118,000 g/mol, from 112,000 g/mol to 118,000 g/mol, from 115,000 g/mol to 118,000 g/mol, from 110,000 g/mol to 115,000 g/mol, from 112,000 g/mol to 115,000 g/mol, or from 110,000 g/mol to 112,000 g/mol.

In one or more embodiments, the multimodal HDPE has a molecular weight (Mz) measured by GPC that is from 600,000 g/mol to 1,300,000 g/mol, such as from 650,000 g/mol to 1,300,000 g/mol, from 700,000 g/mol to 1,300,000 g/mol, from 750,000 g/mol to 1,300,000 g/mol, from 800,000 g/mol to 1,300,000 g/mol, from 850,000 g/mol to 1,300,000 g/mol, from 900,000 g/mol to 1,300,000 g/mol, from 950,000 g/mol to 1,300,000 g/mol, from 1,000,000 g/mol to 1,300,000 g/mol, from 1,050,000 g/mol to 1,300,000 g/mol, from 1,100,000 g/mol to 1,300,000 g/mol, from 1,150,000 g/mol to 1,300,000 g/mol, from 1,200,000 g/mol to 1,300,000 g/mol, from 1,250,000 g/mol to 1,300,000 g/mol, from 600,000 g/mol to 1,250,000 g/mol, from 650,000 g/mol to 1,250,000 g/mol, from 700,000 g/mol to 1,250,000 g/mol, from 750,000 g/mol to 1,250,000 g/mol, from 800,000 g/mol to 1,250,000 g/mol, from 850,000 g/mol to 1,250,000 g/mol, from 900,000 g/mol to 1,250,000 g/mol, from 950,000 g/mol to 1,250,000 g/mol, from 1,000,000 g/mol to 1,250,000 g/mol, from 1,050,000 g/mol to 1,250,000 g/mol, from 1,100,000 g/mol to 1,250,000 g/mol, from 1,150,000 g/mol to 1,250,000 g/mol, from 1,200,000 g/mol to 1,250,000 g/mol, from 600,000 g/mol to 1,200,000 g/mol, from 650,000 g/mol to 1,200,000 g/mol, from 700,000 g/mol to 1,200,000 g/mol, from 750,000 g/mol to 1,200,000 g/mol, from 800,000 g/mol to 1,200,000 g/mol, from 850,000 g/mol to 1,200,000 g/mol, from 900,000 g/mol to 1,200,000 g/mol, from 950,000 g/mol to 1,200,000 g/mol, from 1,000,000 g/mol to 1,200,000 g/mol, from 1,050,000 g/mol to 1,200,000 g/mol, from 1,100,000 g/mol to 1,200,000 g/mol, from 1,150,000 g/mol to 1,200,000 g/mol, from 600,000 g/mol to 1,100,000 g/mol, from 650,000 g/mol to 1,100,000 g/mol, from 700,000 g/mol to 1,100,000 g/mol, from 750,000 g/mol to 1,100,000 g/mol, from 800,000 g/mol to 1,100,000 g/mol, from 850,000 g/mol to 1,100,000 g/mol, from 900,000 g/mol to 1,100,000 g/mol, from 950,000 g/mol to 1,100,000 g/mol, from 1,000,000 g/mol to 1,100,000 g/mol, from 1,050,000 g/mol to 1,100,000 g/mol, from 600,000 g/mol to 1,050,000 g/mol, from 650,000 g/mol to 1,050,000 g/mol, from 700,000 g/mol to 1,050,000 g/mol, from 750,000 g/mol to 1,050,000 g/mol, from 800,000 g/mol to 1,050,000 g/mol, from 850,000 g/mol to 1,050,000 g/mol, from 900,000 g/mol to 1,050,000 g/mol, from 950,000 g/mol to 1,050,000 g/mol, from 1,000,000 g/mol to 1,050,000 g/mol, from 600,000 g/mol to 1,000,000 g/mol, from 650,000 g/mol to 1,000,000 g/mol, from 700,000 g/mol to 1,000,000 g/mol, from 750,000 g/mol to 1,000,000 g/mol, from 800,000 g/mol to 1,000,000 g/mol, from 850,000 g/mol to 1,000,000 g/mol, from 900,000 g/mol to 1,000,000 g/mol, from 950,000 g/mol to 1,000,000 g/mol, from 600,000 g/mol to 950,000 g/mol, from 650,000 g/mol to 950,000 g/mol, from 700,000 g/mol to 950,000 g/mol, from 750,000 g/mol to 950,000 g/mol, from 800,000 g/mol to 950,000 g/mol, from 850,000 g/mol to 950,000 g/mol, from 900,000 g/mol to 950,000 g/mol, from 600,000 g/mol to 900,000 g/mol, from 650,000 g/mol to 900,000 g/mol, from 700,000 g/mol to 900,000 g/mol, from 750,000 g/mol to 900,000 g/mol, from 800,000 g/mol to 900,000 g/mol, from 850,000 g/mol to 900,000 g/mol, from 600,000 g/mol to 850,000 g/mol, from 650,000 g/mol to 850,000 g/mol, from 700,000 g/mol to 850,000 g/mol, from 750,000 g/mol to 850,000 g/mol, from 800,000 g/mol to 850,000 g/mol, from 600,000 g/mol to 800,000 g/mol, from 650,000 g/mol to 800,000 g/mol, from 700,000 g/mol to 800,000 g/mol, from 750,000 g/mol to 800,000 g/mol, from 600,000 g/mol to 750,000 g/mol, from 650,000 g/mol to 750,000 g/mol, from 700,000 g/mol to 750,000 g/mol, from 600,000 g/mol to 700,000 g/mol, from 650,000 g/mol to 700,000 g/mol, or from 600,000 g/mol to 650,000 g/mol.

In one or more embodiments, the multimodal HDPE has a molecular weight ratio (Mz/Mw) measured by GPC that is from 5.0 to 10.0, such as from 5.5 to 10.0, from 6.0 to 10.0, from 6.5 to 10.0, from 7.0 to 10.0, from 7.5 to 10.0, from 8.0 to 10.0, from 8.5 to 10.0, from 9.0 to 10.0, from 9.5 to 10.0, from 5.0 to 9.5, from 5.5 to 9.5, from 6.0 to 9.5, from 6.5 to 9.5, from 7.0 to 9.5, from 7.5 to 9.5, from 8.0 to 9.5, from 8.5 to 9.5, from 9.0 to 9.5, from 5.0 to 9.0, from 5.5 to 9.0, from 6.0 to 9.0, from 6.5 to 9.0, from 7.0 to 9.0, from 7.5 to 9.0, from 8.0 to 9.0, from 8.5 to 9.0, from 5.0 to 8.5, from 5.5 to 8.5, from 6.0 to 8.5, from 6.5 to 8.5, from 7.0 to 8.5, from 7.5 to 8.5, from 8.0 to 8.5, from 5.0 to 8.0, from 5.5 to 8.0, from 6.0 to 8.0, from 6.5 to 8.0, from 7.0 to 8.0, from 7.5 to 8.0, from 5.0 to 7.5, from 5.5 to 7.5, from 6.0 to 7.5, from 6.5 to 7.5, from 7.0 to 7.5, from 5.0 to 7.0, from 5.5 to 7.0, from 6.0 to 7.0, from 6.5 to 7.0, from 5.0 to 6.5, from 5.5 to 6.5, from 6.0 to 6.5, from 5.0 to 6.0, from 5.5 to 6.0, or from 5.0 to 5.5.

In embodiments, the multimodal HDPE disclosed and described herein can be made by any suitable process. In one or more embodiments, the multimodal HDPE disclosed and described herein can be made by gas phase polymerization, slurry polymerization, or a combination of gas phase polymerization and slurry polymerization. In embodiments, the multimodal HDPE disclosed and described herein can be made by gas phase polymerization. For example, the multimodal HDPE disclosed and described herein can be made by the methods disclosed in U.S. Pat. No. 8,455,594, which is incorporated herein by reference in its entirety.

In one or more embodiments, the HDPE disclosed or described herein may be made using a dual-sequential polymerization system, for example, a first gas phase reactor and a second gas phase reactor operating in series. Ethylene, one or more alpha-olefin comonomers, hydrogen, catalyst, for example Ziegler-Natta catalyst, slurried in mineral oil, N₂, and isopentane may be fed continuously into the first reactor. Subsequently, a cocatalyst, for example triethylaluminum (TEAL), may be fed into the first reactor to activate the catalyst. The first polymerization reaction of the ethylene in the presence of 1-hexene is then carried out in the first reactor under the conditions shown below in Table 1 thereby producing first component-catalyst complex. The first component-catalyst complex is transferred to the second reactor. Additional ethylene, hydrogen, cocatalyst, for example TEAL, N₂, and isopentane, may be fed into the second reactor. In embodiments, no additional catalyst is added to the second reactor. The second polymerization reaction of ethylene may be carried out in the second reactor under the conditions shown below in Table 1 thereby producing the first component-catalyst-second component complex. The first component-catalyst-second component complex may be removed from the second reactor in batches into the product chamber, where it may be purged to remove residual hydrocarbons, and then transferred to a drum. The drum may be purged with humidified nitrogen.

TABLE 1

| Co-Monomer Type | 1-hexane |
|---|---|
| Catalyst | Ziegler-Natta |
| Co-Catalyst | 2.5% TEAL |
| First Reactor Type | Gas Phase |
| Second Reactor Type | Gas Phase |
| First Reaction Temp. (° C.) | 85 |
| Second Reaction Temp. (° C.) | 110 |
| First Reaction Pressure (psi) | 348 |
| Second Reaction Pressure (psi) | 394 |
| First Reactor C₂ Partial Pressure (psi) | 26.1 |
| Second Reactor C₂ Partial Pressure (psi) | 81.1 |
| First Reactor H₂/C₂ Molar Ratio | 0.115 |
| Second Reactor H₂/C₂ Molar Ratio | 1.799 |
| First Reactor C₆/C₂ Molar Ratio | 0.0463 |
| Second Reactor C₆/C₂ Molar Ratio | 0.0029 |
| Catalyst Feed Rate (cc/hr) | 6 |
| (First Reactor Only) | |
| First Reactor Isopentane (Mole %) | 8.8 |
| Second Reactor Isopentane (Mole %) | 3.4 |

### Films and Multilayer Films

Multimodal HDPE having the combination of properties described above exhibit excellent processability and tunable performance in films according to some embodiments. The stretching performance of multimodal HDPE described above is more stable than typical other conventional HDPEs and slightly better than other resins. The multimodal HDPE described above can be run at 50% to 100% in the core layer without any issue in some embodiments. The multimodal HDPE described above also requires lower torque to extrude at the same rpm/output than other, conventional HDPE resins in some embodiments. This is a very important feature as many of the existing biaxially oriented polypropylene (BOPP) orientation lines were designed to extrude polypropylene, which use lower torque than most polyethylenes can handle. Thus, when running a BOPP orientation line with polyethylene, the line typically suffers a significant reduction of output, sometimes a reduction of 60% to 70%. Moreover, upgrading the extruder system to accommodate polyethylene can be very costly. Accordingly, an HDPE that can be run 100% without the loss of the production rate can provide a significantly more attractive and recyclable replacement for polypropylene.

While commercially available HDPE have been evaluated and some of them have sufficient stretching performance, most of them are fractional melt index (MI) HDPE, ranging from 0.4 g/10 min to 0.9 g/10 min 12. The HDPE used in some embodiments of the present invention has a higher MI (I₂) at 1.5 g/10 min and a high Mz. Without wishing to be bound to any particular theory, it is believed that the combination of increased MI (I₂) and a high Mz provide the robust stretching performance seen in the HDPE disclosed and described herein for use in some embodiments of the present invention. The relatively lower density is also believed to be an important factor in reducing the crystallization rate, thus, making the web more stable and easier to stretch in both MDO and TDO stages.

In embodiments, the biaxially oriented polyethylene film is a monolayer film comprising the HDPE described above as the only layer.

Where the film is a monolayer film, the layer may contain one or more additives as is generally known. Such additives include antioxidants, such as IRGANOX 1010 and IRGAFOS 168 (commercially available from BASF), ultraviolet light absorbers, antistatic agents, pigments, dyes, nucleating agents, fillers, slip agents, fire retardants, plasticizers, processing aids, lubricants, stabilizers, smoke inhibitors, viscosity control agents, surface modification agents, and anti-blocking agents. The layer composition may, for example, comprise less than 10 percent by the combined weight of one or more additives, based on the weight of the layer in some embodiments, and less than 5 percent by weight in other embodiments. In embodiments, the layer in a multilayer film may be a blend of the HDPE described herein and one or more of LLDPE, LDPE, ethylene-propylene copolymer, polyethylene plastomers, etc.

In embodiments where the film is a monolayer film comprising the HDPE disclosed herein, the film layer, according to embodiments, comprises at least 40 wt % of the HDPE disclosed herein, such as at least 45 wt % of the HDPE disclosed herein, at least 50 wt % of the HDPE disclosed herein, at least 55 wt % of the HDPE disclosed herein, at least 60 wt % of the HDPE disclosed herein, at least 65 wt % of the HDPE disclosed herein, at least 70 wt % of the HDPE disclosed herein, at least 75 wt % of the HDPE disclosed herein, at least 80 wt % of the HDPE disclosed herein, at least 90 wt % of the HDPE disclosed herein, or at least 95 wt % of the HDPE disclosed herein. In embodiments, where the film is a monolayer film comprising the HDPE disclosed herein, the film layer, in embodiments, consists of or consists essentially of the HDPE disclosed herein.

In some embodiments, the biaxially oriented polyethylene film is a multilayer film, where at least one layer comprises the HDPE disclosed herein. For example, a multilayer film can comprise a layer including the HDPE disclosed herein and further comprises other layers typically included in multilayer films depending on the application including, for example, sealant layers, barrier layers, tie layers, other polyethylene layers, polypropylene layers, etc. In embodiments where the film is a multilayer film, the layer comprising the HDPE disclosed and described herein is a core layer of the multilayer film.

As one example, in some embodiments, a multilayer film can comprise the previously-discussed layer comprising the HDPE disclosed herein (Layer B) and another layer (Layer A). Layer A has a top facial surface and a bottom facial surface, wherein the top facial surface of Layer A is in adhering contact with a bottom facial surface of Layer B.

In some such embodiments, Layer A can be a sealant layer formed from one or more ethylene-based polymers as known to those of skill in the art to be suitable for use in a sealant layer.

However, as noted above, Layer A can comprise any number of other polymers or polymer blends. For example, if the multilayer films includes a barrier layer, Layer A could be a tie layer in adhering contact between the outer layer and the barrier layer, and another tie layer could be between the barrier layer and a sealant layer. It should also be understood that the multilayer films of embodiments can include two Layer A's; one on each major surface of Layer B, where a major surface describes a surface with a large surface area and the films have two major surfaces opposite and parallel to one another. Thus, in embodiments, the multilayer film is a 3-layered BOPE film that may be described as an A/B/A film. It should be understood that in embodiments, each Layer A may have the same composition, and in other embodiments, the two Layer A may have different compositions.

In embodiments, the multilayer film may be a five-layered BOPE film having Layer B (such as a core layer) made from the HDPE disclosed and described herein. Present on a major surface of Layer B is a first tie layer (Layer D) and a second tie layer (also Layer D) on a second major surface of Layer B. The first tie layer has a skin layer (Layer A) on the major surface opposite Layer B, and the second tie layer has a skin layer (Layer C) on the major surface opposite Layer B. The 5-layered film may be described as an A/D/B/D/C film.

In one or more embodiments, the tie layers, Layer D, are the same material. In some embodiments, the tie layers, Layer D, are made from the same material as Layer B. Accordingly, in one or more embodiments, Layer B and the ties layers, Layer D, are all made from or comprise the multimodal HDPE disclosed and described herein. However, in other embodiments, the tie layers, Layer D, are not made from the same material as Layer B. In embodiments, Layer D comprises a blend of LLDPE and HDPE (either the HDPE disclosed and described herein or another HDPE) or Layer D may be a tie resin (e.g., ethylene-propylene copolymer or a maleic anhydride modified polymer).

In embodiments, the skin layers, Layer A and Layer C, may be made from the same material. In other embodiments, the skin layers, Layer A and Layer C, may be made from different materials. In an embodiment, the skin layers, Layer A and Layer C, are both made from BOPE, such as INNATE manufactured by the Dow Chemical Company. In embodiments, Layer A and Layer C comprise one or more of LLDPE, a blend of LLDPE and HDPE (either the HDPE disclosed and described herein or another HDPE), HDPE (either the HDPE disclosed and described herein or another HDPE), polypropylene, ethylene-propylene copolymer, or a polyimide.

It should be understood that any of the foregoing layers can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

In embodiments where the film is a multilayer film, at least one layer of the multilayer film comprises the HDPE disclosed herein. The at least one layer comprising the HDPE disclosed herein, according to embodiments, comprises at least 40 wt % of the HDPE disclosed herein, such as at least 45 wt % of the HDPE disclosed herein, at least 50 wt % of the HDPE disclosed herein, at least 55 wt % of the HDPE disclosed herein, at least 60 wt % of the HDPE disclosed herein, at least 65 wt % of the HDPE disclosed herein, at least 70 wt % of the HDPE disclosed herein, at least 75 wt % of the HDPE disclosed herein, at least 80 wt % of the HDPE disclosed herein, at least 90 wt % of the HDPE disclosed herein, or at least 95 wt % of the HDPE disclosed herein. In embodiments, the at least one film layer comprising the HDPE disclosed herein consists of or consists essentially of the HDPE disclosed herein.

The multilayer films may be formed and oriented (for example, biaxially oriented) by any suitable process. Information about these processes may be found in reference texts such as, for example, the Kirk Othmer Encyclopedia, the Modern Plastics Encyclopedia, or the Wiley Encyclopedia of Packaging Technology, 2d edition, A. L. Brody and K. S. Marsh, Eds., Wiley-Interscience (Hoboken, 1997). For example, the multilayer films may be formed through sheet casting or any other suitable casting procedure. Suitable orientation processes include tenter frame technology. When the film is a multilayer film, the various film layers may be co-extruded by any suitable means.

Such polyethylene films (whether monolayer or multilayer), prior to biaxial orientation, can have a variety of thicknesses depending, for example, on the number of layers, the intended use of the film, and other factors. Such polyethylene films, in some embodiments, have a thickness prior to biaxial orientation of 0.8 to 1.0 mm.

In some embodiments, the polyethylene film is biaxially oriented using a tenter frame sequential biaxial orientation process. Such techniques are generally known to those of skill in the art. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

The uniaxially oriented film is introduced into a tenter at a line speed of approximately 20 to 28 meters per minute, preliminarily heated between about 140° C. and 155° C., stretched in the transverse direction at about 120° C. to 130° C. at a stretching ratio of about 6 to 8 times the original width, and then heat-set or annealed at about 105° C. to 120° C. to reduce internal stresses due to the orientation, to minimize thermal shrinkage of the final film, and to give a relatively thermally stable biaxially oriented film.

In embodiments, the film may be drawn at a draw ratio in the machine direction from 4.5:1 to 6.5:1, such as from 4.8:1 to 6.5:1, from 5.0:1 to 6.5:1, from 5.2:1 to 6.5:1, from 5.5:1 to 6.5:1, from 5.8:1 to 6.5:1, from 6.0:1 to 6.5:1, from 6.2:1 to 6.5:1, from 4.5:1 to 6.2:1, from 4.8:1 to 6.2:1, from 5.0:1 to 6.2:1, from 5.2:1 to 6.2:1, from 5.5:1 to 6.2:1, from 5.8:1 to 6.2:1, from 6.0:1 to 6.2:1, from 4.5:1 to 6.0:1, from 4.8:1 to 6.0:1, from 5.0:1 to 6.0:1, from 5.2:1 to 6.0:1, from 5.5:1 to 6.0:1, from 5.8:1 to 6.0:1, from 4.5:1 to 5.8:1, from 4.8:1 to 5.8:1, from 5.0:1 to 5.8:1, from 5.2:1 to 5.8:1, from 5.5:1 to 5.8:1, from 4.5:1 to 5.5:1, from 4.8:1 to 5.5:1, from 5.0:1 to 5.5:1, from 5.2:1 to 5.5:1, from 4.5:1 to 5.2:1, from 4.8:1 to 5.2:1, from 5.0:1 to 5.2:1, from 4.5:1 to 5.0:1, from 4.8:1 to 5.0:1, from 4.5:1 to 4.8:1.

In embodiments, the film may be drawn at a draw ratio in the transverse direction from 6.0:1 to 9.0:1, such as from 6.2:1 to 9.0:1, from 6.5:1 to 9.0:1, from 6.8:1 to 9.0:1, from 7.0:1 to 9.0:1, from 7.2:1 to 9.0:1, from 7.5:1 to 9.0:1, from 7.8:1 to 9.0:1, from 8.0:1 to 9.0:1, from 8.2:1 to 9.0:1, from 8.5:1 to 9.0:1, from 8.8:1 to 9.0:1, from 6.0:1 to 8.8:1, from 6.2:1 to 8.8:1, from 6.5:1 to 8.8:1, from 6.8:1 to 8.8:1, from 7.0:1 to 8.8:1, from 7.2:1 to 8.8:1, from 7.5:1 to 8.8:1, from 7.8:1 to 8.8:1, from 8.0:1 to 8.8:1, from 8.2:1 to 8.8:1, from 8.5:1 to 8.8:1, from 6.0:1 to 8.5:1, from 6.2:1 to 8.5:1, from 6.5:1 to 8.5:1, from 6.8:1 to 8.5:1, from 7.0:1 to 8.5:1, from 7.2:1 to 8.5:1, from 7.5:1 to 8.5:1, from 7.8:1 to 8.5:1, from 8.0:1 to 8.5:1, from 8.2:1 to 8.5:1, from 6.0:1 to 8.2:1, from 6.2:1 to 8.2:1, from 6.5:1 to 8.2:1, from 6.8:1 to 8.2:1, from 7.0:1 to 8.2:1, from 7.2:1 to 8.2:1, from 7.5:1 to 8.2:1, from 7.8:1 to 8.2:1, from 8.0:1 to 8.2:1, from 6.0:1 to 8.0:1, from 6.2:1 to 8.0:1, from 6.5:1 to 8.0:1, from 6.8:1 to 8.0:1, from 7.0:1 to 8.0:1, from 7.2:1 to 8.0:1, from 7.5:1 to 8.0:1, from 7.8:1 to 8.0:1, from 6.0:1 to 7.8:1, from 6.2:1 to 7.8:1, from 6.5:1 to 7.8:1, from 6.8:1 to 7.8:1, from 7.0:1 to 7.8:1, from 7.2:1 to 7.8:1, from 7.5:1 to 7.8:1, from 6.0:1 to 7.5:1, from 6.2:1 to 7.5:1, from 6.5:1 to 7.5:1, from 6.8:1 to 7.5:1, from 7.0:1 to 7.5:1, from 7.2:1 to 7.5:1, from 6.0:1 to 7.2:1, from 6.2:1 to 7.2:1, from 6.5:1 to 7.2:1, from 6.8:1 to 7.2:1, from 7.0:1 to 7.2:1, from 6.0:1 to 7.0:1, from 6.2:1 to 7.0:1, from 6.5:1 to 7.0:1, from 6.8:1 to 7.0:1, from 6.0:1 to 6.8:1, from 6.2:1 to 6.8:1, from 6.5:1 to 6.8:1, from 6.0:1 to 6.5:1, from 6.2:1 to 6.5:1, or from 6.0:1 to 6.2:1.

After orientation, the biaxially oriented film has a thickness of 10 to 60 microns in some embodiments. In some embodiments, the biaxially oriented film has a thickness of 10 to 30 microns.

In some embodiments, depending for example on the end use application, the biaxially oriented polyethylene film can be corona treated, plasma treated, or printed using techniques known to those of skill in the art.

### Multilayer Film Properties

In embodiments, multilayer films including a layer comprising the multimodal HDPE disclosed and described herein at least in a core layer have a haze from 2% to 70%, such as from 5% to 70%, from 10% to 70%, from 15% to 70%, from 20% to 70%, from 25% to 70%, from 30% to 70%, from 35% to 70%, from 40% to 70%, from 45% to 70%, from 50% to 70%, from 55% to 70%, from 60% to 70%, from 65% to 70%, from 2% to 65%, from 5% to 65%, from 10% to 65%, from 15% to 65%, from 20% to 65%, from 25% to 65%, from 30% to 65%, from 35% to 65%, from 40% to 65%, from 45% to 65%, from 50% to 65%, from 55% to 65%, from 60% to 65%, from 2% to 60%, from 5% to 60%, from 10% to 60%, from 15% to 60%, from 20% to 60%, from 25% to 60%, from 30% to 60%, from 35% to 60%, from 40% to 60%, from 45% to 60%, from 50% to 60%, from 55% to 60%, from 2% to 60%, from 5% to 60%, from 10% to 60%, from 15% to 60%, from 20% to 60%, from 25% to 60%, from 30% to 60%, from 35% to 60%, from 40% to 60%, from 45% to 60%, from 50% to 60%, from 55% to 60%, from 2% to 55%, from 5% to 55%, from 10% to 55%, from 15% to 55%, from 20% to 55%, from 25% to 55%, from 30% to 55%, from 35% to 55%, from 40% to 55%, from 45% to 55%, from 50% to 55%, from 2% to 50%, from 5% to 50%, from 10% to 50%, from 15% to 50%, from 20% to 50%, from 25% to 50%, from 30% to 50%, from 35% to 50%, from 40% to 50%, from 45% to 50%, from 2% to 45%, from 5% to 45%, from 10% to 45%, from 15% to 45%, from 20% to 45%, from 25% to 45%, from 30% to 45%, from 35% to 45%, from 40% to 45%, from 2% to 40%, from 5% to 40%, from 10% to 40%, from 15% to 40%, from 20% to 40%, from 25% to 40%, from 30% to 40%, from 35% to 40%, from 2% to 35%, from 5% to 35%, from 10% to 35%, from 15% to 35%, from 20% to 35%, from 25% to 35%, from 30% to 35%, from 2% to 30%, from 5% to 30%, from 10% to 30%, from 15% to 30%, from 20% to 30%, from 25% to 30%, from 2% to 25%, from 5% to 25%, from 10% to 25%, from 15% to 25%, from 20% to 25%, from 2% to 20%, from 5% to 20%, from 10% to 20%, from 15% to 20%, from 2% to 20%, from 5% to 20%, from 10% to 20%, from 15% to 20%, from 2% to 15%, from 5% to 15%, from 10% to 15%, from 2% to 10%, from 5% to 10%, or from 2% to 5%.

In one or more embodiments, multilayer films including the multimodal HDPE disclosed and described herein at least in a core layer have a 1% secant modulus in the machine direction (MD) that is from 500 MPa to 2500 MPa, such as from 750 MPa to 2500 MPa, from 1000 MPa to 2500 MPa, from 1250 MPa to 2500 MPa, from 1500 MPa to 2500 MPa, from 1750 MPa to 2500 MPa, from 2000 MPa to 2500 MPa, from 2250 MPa to 2500 MPa, from 500 MPa to 2250 MPa, from 750 MPa to 2250 MPa, from 1000 MPa to 2250 MPa, from 1250 MPa to 2250 MPa, from 1500 MPa to 2250 MPa, from 1750 MPa to 2250 MPa, from 2000 MPa to 2250 MPa, from 500 MPa to 2000 MPa, from 750 MPa to 2000 MPa, from 1000 MPa to 2000 MPa, from 1250 MPa to 2000 MPa, from 1500 MPa to 2000 MPa, from 1750 MPa to 2000 MPa, from 500 MPa to 1750 MPa, from 750 MPa to 1750 MPa, from 1000 MPa to 1750 MPa, from 1250 MPa to 1750 MPa, from 1500 MPa to 1750 MPa, from 500 MPa to 1500 MPa, from 750 MPa to 1500 MPa, from 1000 MPa to 1500 MPa, from 1250 MPa to 1500 MPa, from 500 MPa to 1250 MPa, from 750 MPa to 1250 MPa, from 1000 MPa to 1250 MPa, from 500 MPa to 1000 MPa, from 750 MPa to 1000 MPa, or from 500 MPa to 750 MPa.

### Articles

In various embodiments, the multilayer films disclosed herein can be used to form articles such as packages. Such articles can be formed from any of the multilayer films described herein. Examples of packages that can be formed from multilayer films of various embodiments can include flexible packages, sachets, pouches, stand-up pouches, and pre-made packages or pouches. In some embodiments, multilayer films described herein can be used for food packages, such as packages for meats, cheeses, cereal, nuts, juices, sauces, chips, snacks, and the like. Such packages can be formed using techniques known to those of skill in the art based on the teachings herein and based on the particular use for the package (e.g., type of food, amount of food, etc.).

### Testing Methods

The test methods include the following:

### Haze

Haze was measured according to ASTM D1003. A Hazeguard Plus (BYK-Gardner USA; Columbia, MD) is used for testing. The total haze is reported as the average of five measurements.

### Density

Compression molded samples for density measurement were prepared according to ASTM D 4703. Density measurements were performed following ASTM D792, Method B within 2 hours of molding.

### Melt Index

Melt index (I₂) were measured in accordance to ASTM D-1238 at 190° C. and a 2.16 kg load. 12 values are reported in dg/min.

### Secant Modulus

Secant modulus were measured based on tensile tests according to ASTM D882. The film is conditioned for at least 40 hours after film production at 23° C. (+/−2° C.) and 50% R.H (+/−10%) as per ASTM standards. Standard testing conditions are 23° C. (+/−2° C.) and 50% R.H (+/−10%) as per ASTM standards. Tensile test strips are cut from a film in the machine and cross directions (MD and CD). Strips are 1 inch wide by approximately 8 inches long. The samples are loaded onto a tensile testing frame using line grip jaws (flat rubber on one side of the jaw and a line grip the other) set at a gauge length (line grip to line grip distance) of 2 inches. The samples are then strained at a crosshead speed of 20 inches/min. From the resulting stress-strain curve the elastic modulus (from the initial portion of the stress-strain curve, often referred to as the Young's Modulus) and secant modulus at 1% and 2% strain are calculated.

### Gel Permeation Chromatography (GPC)

Molecular weights (Mw, Mz, Mn, etc.) were measured using GPC unless otherwise indicated.

The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$${Mz}_{( GPC )} = \frac{{\sum }^{i} ( {IR}_{i} * {M}_{{polyethylene}_{i}^{2}} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

$$Flowrate ( effective ) = Flowrate ( nominal ) * ( RV ( FM Calibrated ) / RV ( FM Sample ) ) . \qquad ( EQ7 )$$

### EXAMPLES

The following examples illustrate features of the present disclosure but are not intended to limit the scope of the disclosure.

Five-layer biaxially oriented polyethylene films were produced using a 2.1 meters wide pilot tenter frame line. The films were produced using a 5-layer (ADBDC) die with a die gap of approximately 3.1 mm, cast on a chill drum using an air knife pinner. The films were stretched at a 5.5: to 6.0:1 draw ratio in the machine direction through a series of heated and differentially speed rolls, followed by stretching in the transverse direction at an 8:1 draw ratio. The configurations of each extruder is shown in Table 2 below.

TABLE 2

| Extruders | Type | Diameter | L/D |
|---|---|---|---|
| A - skin (chill roll side) | single | 1.25″ | 24:1 |
| B - core layer | single | 2.5″ | 30:1 |
| C - skin | single | 1.25″ | 24:1 |
| D - tie layer | single | 1.5″ | 24:1 |

A multilayer film with a width of 280 mm to 290 mm and thickness of 0.8 mm to 1.0 mm was coextruded at processing temperatures of approximately 240° C. to 260° C. through a 5-layer die and cast onto a cooling drum whose surface temperature was controlled between 40° C. and 90° C. to solidify the non-oriented film at a casting speed of about 4 meters per minute to 6 meters per minute. The non-oriented film was preheated in the machine direction during stretching at about 65° C. to 130° C., stretched in the machine direction at about 110° C. to 130° C. at a stretching ratio of 5 to 6 times the original length. The resulting stretched sheet was annealed at about 30° C. to 70° C. to reduce heat shrinkage and to obtain a uniaxially oriented film.

The uniaxially oriented film was introduced into a tenter at a line speed of approximately 20 meters per minute to 28 meters per minute, preliminarily heated between about 140° C. and 155° C., stretched in the transverse direction at about 120° C. to 130° C. at a stretching ratio of about 6 to 8 times the original width, and then heat-set or annealed at about 105° C. to 120° C. to reduce internal stresses due to the orientation, to minimize thermal shrinkage of the final film, and to give a relatively thermally stable biaxially oriented film. After biaxial orientation, the thickness of the coextruded film overall was nominally about 20 microns; the outer layers (extruders A&C) were about 1 micrometer each, the tie layers (extruder D split into two layers) were about 0.65 micrometers to 0.8 micrometer each and the core layer (extruder B) was about 16 micrometers to 17 micrometers thick. The biaxially oriented multi-layer film may be wound in roll form. The machine direction orientation relaxation ratio may be between 3% and 5%, the transverse direction orientation relaxation ratio may be between 3% and 6%.

In all the experiments the core layer (extruder B) and the tie layers (extruder D) used the same HDPE material. The skin layers (extruder A and C) used the same LLDPE material. The final film width is about 1.1 m.

The LLDPE material used in the skin layers was INNATE™ TF80 from The Dow Chemical Company having a 1.7 g/10 min melt index and 0.926 g/cc density. The characteristics of the HDPE materials used in the tie and the core layers are listed in Table 3 below. HDPE-1 was a bimodal HDPE produced via a dual reactor process according to the processes described in U.S. Pat. No. 8,445,594 Example 6, which is incorporated herein by reference in its entirety.

TABLE 3

| | Unit | HDPE-1 | HDPE-A | HDPE-B | HDPE-C |
|---|---|---|---|---|---|
| Density | g/cc | 0.955 | 0.955 | 0.958 | 0.967 |
| I₂ | g/10 min | 1.47 | 0.87 | 0.44 | 1.16 |
| I₁₀/I₂ | | 12.8 | 12.4 | 16.4 | 15.1 |
| I₂₁/I₂ | | 68 | 56 | 85 | 113 |
| Mn_{(GPC)} | g/mol | 9,325 | 16,532 | 14,804 | 10,226 |
| Mw_{(GPC)} | g/mol | 122,201 | 101,087 | 136,630 | 109,074 |
| Mz_{(GPC)} | g/mol | 741,347 | 299,039 | 1,415,618 | 455,363 |
| Mw/Mn_{(GPC)} | | 13.10 | 6.11 | 9.23 | 10.67 |
| Mz/Mw_{(GPC)} | | 6.07 | 2.96 | 10.36 | 4.17 |

In particular, HDPE-1 was made using a dual-sequential polymerization system, comprising a first gas phase reactor and a second gas phase reactor operating in series. Ethylene, one or more alpha-olefin comonomers, hydrogen, a Ziegler-Natta catalyst, slurried in mineral oil, N₂, and isopentane were fed continuously into the first reactor. Subsequently, a triethylaluminum (TEAL) co-catalyst, was continuously fed into the first reactor to activate the catalyst. The first polymerization reaction of the ethylene in the presence of 1-hexene was then carried out in the first reactor under the conditions shown below in Table 4 thereby producing a first component-catalyst complex. The first component-catalyst complex was continuously transferred to the second reactor. Additional ethylene, hydrogen, TEAL co-catalyst, N₂, and isopentane, was continuously fed into the second reactor. No additional catalyst was added to the second reactor. The second polymerization reaction of ethylene was carried out in the second reactor under the conditions shown below in Table 4 thereby producing the first component-catalyst-second component complex. The first component-catalyst-second component complex was removed from the second reactor in batches into the product chamber, where it was purged to remove residual hydrocarbons, and then transferred to a drum. The drum was purged with humidified nitrogen.

TABLE 4

| Co-Monomer Type | 1-hexane |
|---|---|
| Catalyst | Ziegler-Natta |
| Co-Catalyst | 2.5% TEAL |
| First Reactor Type | Gas Phase |
| Second Reactor Type | Gas Phase |
| First Reaction Temp. (° C.) | 85 |
| Second Reaction Temp. (° C.) | 110 |
| First Reaction Pressure (psi) | 348 |
| Second Reaction Pressure (psi) | 394 |
| First Reactor C₂ Partial Pressure (psi) | 26.1 |
| Second Reactor C₂ Partial Pressure (psi) | 81.1 |
| First Reactor H₂/C₂ Molar Ratio | 0.115 |
| Second Reactor H₂/C₂ Molar Ratio | 1.799 |
| First Reactor C₆/C₂ Molar Ratio | 0.0463 |
| Second Reactor C₆/C₂ Molar Ratio | 0.0029 |
| Catalyst Feed Rate (cc/hr) | 6 |
| (First Reactor Only) | |
| First Reactor Isopentane (Mole %) | 8.8 |
| Second Reactor Isopentane (Mole %) | 3.4 |

The polymer was further processed in a mixer/pelletizer. Additional additives, such as 400 ppm Irganox 1010 and 500 ppm Irgafos 168, were added to the polymer. The polymer was melted in the mixer, and additives were be dispersed therein.

HDPE-A was a bimodal HDPE produced via a dual solution reactor process. HDPE-B is a unimodal HDPE produced via a single reactor process via a chrome type catalyst. HDPE-C was a bimodal HDPE produced via a dual solution reactor process at according to the processes described in PCT Application No. PCT/US2021/024140, which is incorporated herein by reference in its entirety.

The formulations of Example 1, which was prepared in accordance with embodiments disclosed and described herein, and Comparative Example A, Comparative Example B, and Comparative Example C are listed in Table 5. Table 5 also includes the stretching performance at TDO, web appearance after TDO, torque requirement at the main core extruder B as well as the haze and the modulus of each film. As is shown in Table 5, the sample with HDPE 1 in the tie and the core layers exhibited the best stretching stability at TDO, a low web sagging after TDO, the most homogeneous web appearance, and a low gauge variation at the same time. Stretching stability, web appearance and low gauge variation are among the most important requirements for producing high quality BOPE films at large industry scale tenter frame lines. Samples using HDPE 1 also required a low torque at the main core extruder, which is also important to maintain a high output at large industry scale tenter frame lines.

TABLE 5

| | | Comparative | Comparative | Comparative |
|---|---|---|---|---|
| Extruder | Example 1 | Example A | Example B | Example C |
| A - skin (chill roll | TF80 | TF80 | TF80 | TF80 |
| side) | | | | |
| D - tie layer | HDPE 1 | HDPE A | HDPE B | HDPE C |
| B - core layer | HDPE 1 | HDPE A | HDPE B | HDPE C |
| D - tie layer | HDPE 1 | HDPE A | HDPE B | HDPE C |
| C - skin | TF80 | TF80 | TF80 | TF80 |
| Ranking in | 1 | 3 | 2 | 4 |
| stretching stability | | | | |
| at TDO* | | | | |
| Web sagging after | low | high | low | high |
| TDO | | | | |
| Web appearance | homogeneous | inhomogeneous | slightly | inhomogeneous |
| | | with a lot of | inhomogeneous | with a lot of |
| | | MD bands | | MD bands |
| Gauge variation | low | high | low | high |
| Motor torque at | 53.6 | 58.7 | 60.8 | 47.5 |
| extruder B core | | | | |
| layer (%) | | | | |
| Haze (%) | 58 | 46 | 31 | 75 |
| Secant modulus - | 1770 | 2119 | 2215 | 1996 |
| 1% MD (MPa) | | | | |

*Ranking in stretching stability at TDO: 1-best, 4-worst

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A film comprising at least one layer, the at least one layer comprising:
a multimodal high density polyethylene comprising:
a melt index (I₂) that is from 0.8 g/10 min to 5.0 g/10 min;
a density that is from 0.950 g/cc to 0.965 g/cc;
a polydispersity (Mw/Mn) that is from 10 to 20; and
a molecular weight (Mz) that is from 500,000 g/mol to 1,000,000 g/mol,
wherein the film is a biaxially oriented polyethylene film; and
the film is stretched in the machine direction at a stretching ratio of 5 to 6 times the original length and in the transverse direction at a stretching ratio of 6 to 8 times the original width.

2. The film of claim 1, wherein the multimodal high density polyethylene comprises a melt index (I₂) that is from 1.0 g/10 min to 3.0 g/10 min.

3. The film of any one of claim 1, wherein the multimodal high density polyethylene comprises a density that is from 0.955 g/cc to 0.960 g/cc.

4. The film of any one of claim 1, wherein the multimodal high density polyethylene comprises a polydispersity (Mw/Mn) that is from 10 to 15.

5. The film of claim 1, wherein the multimodal high density polyethylene comprises a molecular weight Mz that is from 550,000 g/mol to 900,000 g/mol.

6. The film of claim 1, wherein the multimodal high density polyethylene comprises a melt index ratio (I₁₀/I₂) that is from 5.0 to 15.0.

7. The film of claim 1, wherein the multimodal high density polyethylene comprises a molecular weight Mw that is from 110,000 g/mol to 135,000 g/mol.

8. The film of claim 1, wherein the multimodal high density polyethylene comprises a molecular weight Mn that is from 9,000 g/mol to 10,000 g/mol.

9. A biaxially oriented multilayer film comprising:
a core layer comprising a multimodal high density polyethylene comprising:
a melt index (I₂) that is from 0.8 g/10 min to 5.0 g/10 min;
a density that is from 0.950 g/cc to 0.965 g/cc;
a polydispersity (Mw/Mn) that is from 10 to 20; and
a molecular weight (Mz) that is from 500,000 g/mol to 1,000,000 g/mol;
a first layer positioned on a first side of the core layer; and
a second layer positioned on a second side of the core layer.

10. The biaxially oriented multilayer film of claim 9, wherein at least one of the first layer and the second layer comprises a multimodal high density polyethylene comprising:
a melt index (I₂) that is from 0.8 g/10 min to 5.0 g/10 min;
a density that is from 0.950 g/cc to 0.965 g/cc;
a polydispersity (Mw/Mn) that is from 10 to 20; and
a molecular weight (Mz) that is from 500,000 g/mol to 1,000,000 g/mol.

11. The biaxially oriented multilayer film of claim 9, wherein the first layer and the second layer are made from the same material.

12. The biaxially oriented multilayer film of claim 9, wherein
a first side of the first layer is positioned on the first side of the core layer and a first side of the second layer is positioned on the second side of the core layer,
a third layer is positioned on a second side of the first layer, and
a fourth layer is positioned on a second side of the second layer.

13. The biaxially oriented multilayer film of claim 9, wherein the multilayer film comprises a haze from 2% to 70%.

14. The biaxially oriented multilayer film of claim 9, wherein the multilayer film comprises a 1% secant modulus in MD (machine direction) that is from 500 MPa to 2500 MPa.

15. An article comprising the film of claim 1.

16. An article comprising the biaxially oriented multilayer film of claim 9.
